(19) United States
(12) Patent Application Publication
(10) Pub. No.: US 2012/0302116 A1
(43) Pub. Date: Nov. 29, 2012

(54) Buoyant Apparatus for Use on a Wearer's Foot

(76) Inventor: Beth Chester, Dennis Port, MA (US)

(21) Appl. No.: 13/477,110

(22) Filed: May 22, 2012

Related U.S. Application Data
(60) Provisional application No. 61/489,315, filed on May 24, 2011.

(51) Int. Cl. B63B 35/83; B65D 63/00; F16B 45/00; B63B 1/00

(52) U.S. Cl. 441/76

(57) ABSTRACT

A buoyant apparatus for use on a wearer's foot having an outer frame including a foot insert and a plurality of fins. The outer frame is substantially oval having a bow end, center, and stern end such that the outer frame is widest at the center and narrowest at the bow and stern ends. A rudder extends outwardly horizontally from the stern end. The outer frame has a bottom surface having a plurality of fins extending downwardly therefrom. A center fin is centrally positioned along the bottom surface of the outer frame from the bow end to the stern end. The center fin has a centrally positioned substantially circular hole having a valve. A plurality of stabilizing fins are positioned around the center fin. A foot insert is integrally coupled to the outer frame at the center for accepting the wearer's foot therein.

### CROSS REFERENCE TO RELATED APPLICATION

This application claims priority from and takes the benefit of U.S. Provisional Application Ser. No. 61/489,315 filed on May 24, 2012, the contents of which are hereby incorporated by reference.

### BACKGROUND OF THE INVENTION

1. Field of the Invention

This invention relates generally to aquatic recreation and sports, and more particularly, to a specifically designed buoyant apparatus for travelling along the surface of water. In particular, the buoyant apparatus has an outer frame having a foot insert for easily positioning the wearer's foot therein and a plurality of fins to maintain flotation characteristics.

Water enthusiasts have enjoyed recreational activity and sports such as water skiing, wake boarding, paddle boarding, and surfing to travel along the surface of water while enjoying the outdoors. Most of the current devices for recreational water activity do not allow for stabilized and controlled movement through the water. For example, a person must kneel or lay onto top of a surfboard to paddle in a desired direction. The direction and stabilization of a surfboard is hard to control because the bottom of the surfboard is generally flat with only one end having a downwardly extending fin to provide control. In addition, water skis require the forward movement and velocity of a boat to pull the wearer and generate enough pressure for the water skis to maintain stability.

In addition, common water recreational devices only engage the upper body muscles and do not provide a full body workout. For example, when paddling in a kayak, only upper body muscles are engaged to maneuver the paddle through the water. These common devices do not allow for a person to engage both the lower body and the upper body simultaneously.

The present invention seeks to provide a convenient and environmentally friendly buoyant apparatus for water recreation and sports which provides directional stability and controlled movement.

2. Description of the Related Art

U.S. Pat. No. 3,936,896 to Creamer discloses a shoe of lightweight, buoyant material adapted to be loosely worn on the foot below water level to cause the walking movements of the wearer to simulate those of an astronaut walking on the moon. The shoes can have a sole and toe design to simulate the wear of an astronaut or the foot of an animal.

U.S. Pat. No. 4,117,562 to Schaumann discloses a water walker which is attachable to a user's foot and which, when used in pairs, i.e., one walker for each of a user's feet, allows the user to move across the surface of a body of water while standing upright, includes a buoyant flotation member, a pair of spaced apart runners longitudinally extending along the bottom of the buoyant member, and at one water control mechanism in the space between the runners.

U.S. Pat. No. 4,530,668 to Braun discloses a flotation device is provided for enabling a person to stride upon a body of water. The device, to be worn on each foot of the user, is comprised of a series of horizontally elongated parallel keels, and flaps pivotably suspended from the keels.

U.S. Pat. No. 4,801,284 to Lieu discloses a water walking shoe having an outer bell portion constructed from a rigid plastic material. Vent holes are spaced about the periphery of the outer bell. An inner bell is constructed from a thin plastic sheet material and is received within the outer bell.

U.S. Pat. No. 4,939,851 to Miller discloses a boat shoe that includes a sole constructed to allow for the flow of water from the interior of the shoe to the exterior of the shoe. The sole includes an innersole which is a removable orthotic with a series of openings through which water can pass.

U.S. Pat. No. 5,593,334 to Thayer discloses a water walker for walking or skiing over the water. Each walker consists of multiple inflatable tubes attached to one another and with an opening in the middle for inserting the foot. The foot rests on a foot plate supported by a tubular structural support system running horizontally the length of the walker.

U.S. Pat. No. 7,121,910 to Rosen discloses an apparatus for the purpose of floatation and transportation on water comprises a pair of buoyant wing-shaped floats and foot wells in the floats designed to be under the center of buoyancy of each float. Accessories may be attached to one or more floats.

While these methods may be suitable for the particular purpose employed, or for general use, they would not be as suitable for the purposes of the present invention as disclosed hereafter.

### SUMMARY OF THE INVENTION

It is an object of the invention to provide an apparatus which allows the wearer to travel along the surface of water. Accordingly, the present invention is a buoyant apparatus for use on a wearer's foot having an outer frame including a foot insert and a plurality of fins which allow the wearer to travel in a desired direction along the surface of the water while maintaining flotation characteristics.

It is an object of the invention to provide a neutrally buoyant apparatus. Accordingly, the outer frame of the buoyant apparatus of the present invention allows the weight of the wearer, when in use, to oppose upward pressure of displaced water thus creating the neutral buoyancy required to maintain flotation of the buoyant apparatus along the surface of the water.

It is another object of the invention to provide an apparatus suitable for a wearer's foot. Accordingly, a foot insert is integrally coupled within the outer frame of the present apparatus which allows the wearer to secure their foot into the outer frame thus maintaining control while moving along the surface of the water.

It is another object of the invention to allow the wearer to maneuver the apparatus when on the surface of the water. Accordingly, a rudder extends outwardly horizontally from the stern end of the outer frame of the present apparatus which provides balance and helps to maneuver the apparatus when travelling along the surface of the water.

It is yet another object of the invention to provide increased stability when in use. Accordingly, a plurality of fins extend downwardly and outwardly from the bottom surface of outer frame of the present apparatus maintaining the equilibrium of the apparatus as the pressure exerted onto the apparatus changes as the wearer travels along the surface of the water.

It is another object of the invention to provide directional stability when in use. Accordingly, a center fin extends downwardly from the bottom surface of the outer frame of the present invention allowing the wearer to move a forward direction by angling the center fin in the desired direction.

It is another object of the invention to allow the wearer to glide along the surface of the water. Accordingly, to move in a forward direction, the wearer alternates their body weight while extending each foot outwardly and thus glides along the surface of the water moving in a forward direction.

It is yet another object of the invention to increase and decrease resistance such that wearer can easily travel in the desired direction. Accordingly, the center fin of the outer frame of the buoyant apparatus of the present invention has hole which includes a valve that prevents water to flow through the hole increasing resistance when the wearer extends their leg in a forward direction and allows water to flow through the hole creating less resistance as the wearer alternates their body weight thus maintaining stability and control while the wearer travels in the desired direction.

It is another object of the invention to provide a buoyant apparatus suitable for all ages. Accordingly, the outer frame is available in a variety of dimensions to suit the size of the wearer's foot.

It is yet another object of the invention to provide an environmentally friendly water apparatus. Accordingly, the buoyant apparatus of the present invention is usable without the need for a motorized boat thus reducing excess pollution.

This invention is a buoyant apparatus for use on a wearer's foot having an outer frame including a foot insert and a plurality of fins. The outer frame is substantially oval having a bow end, center, and stern end such that the outer frame is widest at the center and narrowest at the bow and stern ends. A rudder extends outwardly horizontally from the stern end. The outer frame has a bottom surface having a plurality of fins extending downwardly therefrom. A center fin is centrally positioned along the bottom surface of the outer frame from the bow end to the stern end. The center fin has a centrally positioned substantially circular hole having a valve. A plurality of stabilizing fins is positioned around the center fin. A foot insert is integrally coupled to the outer frame at the center for accepting the wearer's foot therein.

### BRIEF DESCRIPTION OF THE DRAWINGS

In the drawings, like elements are depicted by like reference numerals. The drawings are briefly described as follows.

FIG. 1 is a diagrammatic perspective view of the buoyant apparatus of the present invention for use on a left foot having an outer frame including a foot insert and rudder.

FIG. 2 is a side view of the buoyant apparatus of the present invention for use on a left foot having a center fin and valve.

FIG. 3 is a bottom plan view of the outer frame of the buoyant apparatus having a plurality of stabilizing fins.

FIG. 4 is diagrammatic perspective view of the buoyant apparatus of the present invention in use.

### DETAILED DESCRIPTION OF THE PREFERRED EMBODIMENTS

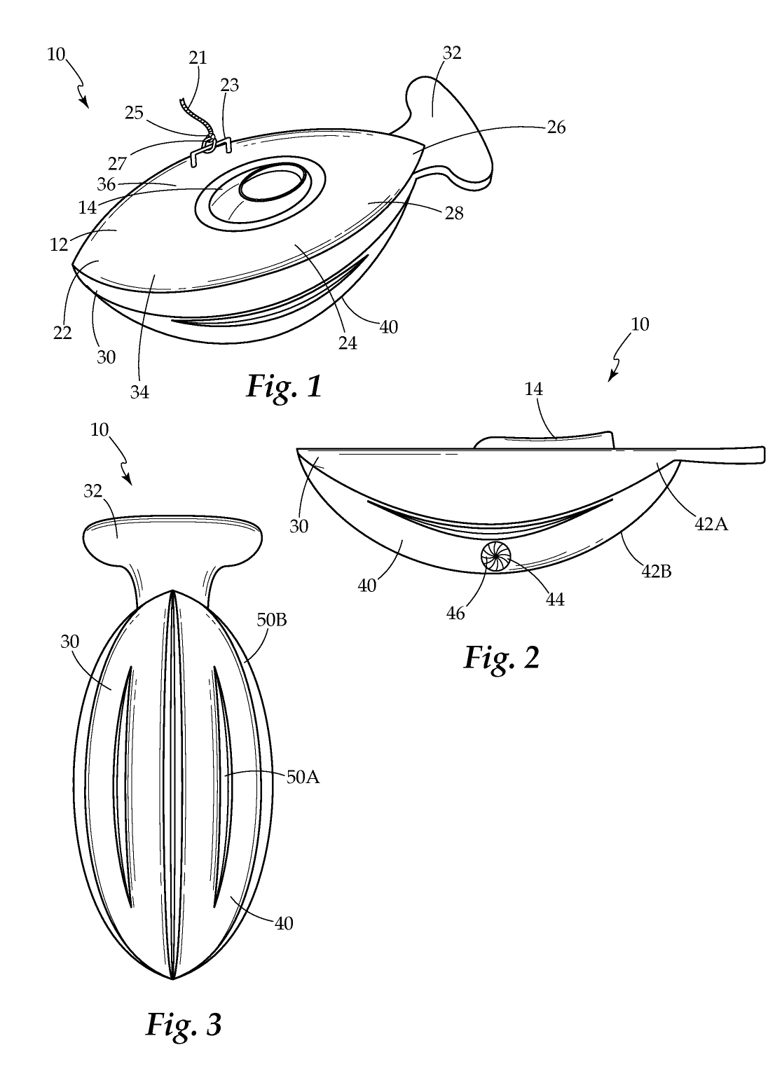

FIG. 1 illustrates the buoyant apparatus 10 of the present invention for recreational water activities and sports. In its broadest context, the buoyant apparatus 10 has an outer frame 12 having a foot insert 14 for accepting the wearer's foot therein, and a plurality of fins 20 for providing stability and control. The buoyant apparatus 10 is shown and described for the wearer's left foot. An alternate embodiment suitable for the wearer's right foot is contemplated, which is a mirror image of the buoyant apparatus 10 as shown and described.

Current devices for recreational water activity and sports do not allow for stable and controlled movement while maintaining flotation principles along the surface of the water without the need for additional equipment. Current devices, such as water skis, require the forward momentum of a boat to provide the extra pressure required to keep the skis and wearer afloat. Likewise, kayaks require the user to maintain a paddle stroke to move the kayak in a desired direction.

The outer frame 12 of the buoyant apparatus 10 is substantially oval and is uniquely designed to allow water to displace as the wearer applies weight to the buoyant apparatus 10. The wearer's weight opposes the upward pressure of the displaced water thus creating neutral buoyancy and allowing the buoyant apparatus 10 to continuously remain afloat while along the surface of the water. Similar to kayaks, canoes, and boats, the outer frame 12 is substantially hollow. Thus, the buoyant apparatus 10 displaces water while remaining lightweight. As such, the buoyant apparatus 10 is suitable for calm waterways such as bays, lakes, and ponds and maneuverable through rough waterways such as rivers and oceans. An alternate embodiment is contemplated wherein the buoyant apparatus 10 is substantially rectangular while still maintaining neutral buoyancy and remaining afloat along the surface of the water.

The outer frame 12 is similar to a miniaturized hull and has a bow end 22, center 24 and stern end 26. The outer frame 12 is widest at the center 24 and narrowest at the bow and stern ends 22, 26. The outer frame 12 has a port side 34 and starboard side 36 as defined by known nautical terms. The outer frame 12 has a top surface 28 and a bottom surface 30 such that when in use the bottom surface 30 is submerged under water similar to a displacement boat such as a canoe or kayak. This allows the buoyant apparatus 10 to glide easily through the water with less resistive forces.

In the preferred embodiment, the outer frame 12 is made from plastic for providing durability and buoyancy while in use. In alternate embodiments, the outer frame 12 is made from foam encased within fiberglass to provide a smooth surface. Other materials well known in the art for water sports equipment are contemplated. Preferably, the outer frame 12 is suitable for all ages and is available in sizes for adults and children. For children up to forty six pounds, the outer frame 12 is approximately two and one half feet (2½′) in length, nine and one half inches (9½″) in width and ten inches (10″) in height at the center 24 of the outer frame 12, tapering to six inches (6″) in height at the front and back ends 22, 26. Similarly for adults up to two hundred and fifty pounds, the outer frame 12 is approximately four feet (4′) in length, twelve and one half inches (12½″) in width and twelve inches (12″) in height at the center 24 of the outer frame 12, tapering to eight inches (8″) in height at the front and back ends 22, 26. The increase in height at the center 24 of the outer frame creates a silhouette similar to a round bottom boat further increasing buoyancy of the outer frame 12 and allowing the buoyant apparatus 10 to move easily through the water. Other dimensions are contemplated for the outer frame 12 to suit wearers of different foot sizes and varying weight groups. In the preferred embodiment, the outer frame 12 is painted to provide a smooth surface for decreased water resistance. The outer frame 12 is painted in a plurality of designs or colors to suit the wearer.

The foot insert 14 is integrally coupled within the outer frame 12 at the center 24 such that when in use, the wearer's foot is positioned inside the foot insert 14 inside the outer frame 12. Positioning the foot insert 14 at the center 24 of the outer frame 12 allows the weight of the wearer to simultaneously oppose the upward pressure of the displaced water. Thus, allowing the wearer to fully balance their weight within the buoyant apparatus 10 for increased control. The foot insert 14 is similar to well known boots found on water skis or wake boards. In the preferred embodiment, the foot inserts 14 are adjustable for different size feet such that the wearer's foot fits securely therein to aid in controlling the apparatus 10. Preferably, the foot insert 14 is made of soft durable rubber having a slick resistant coating to prevent the wearer's bare foot from sliding while within the foot insert 14.

A bungee cord 21 removably couples to the top surface 28 of the outer frame to prevent the buoyant apparatus 10 on each foot of the wearer from straying too far apart while in use. FIG. 1 illustrates the buoyant apparatus 10 suitable for a wearer's left foot wherein a hook 23 is coupled to the top surface 28 on the starboard side 36 of the foot insert 14 of the outer frame 12. The bungee cord is similar to well known stretchable and durable bungee cords in the art. The bungee cord has two ends 25 each having a clip 27 to removably couple the bungee cord 21 to the hook 23. Similarly, for the buoyant apparatus 10 suitable for a wearer's right foot, the hook 23 is coupled to the top surface 28 on the port side 34 of the foot insert 14 of the outer frame such that the bungee cord 21 can removably couple thereto via the clip 27 on the end 25 of the bungee cord 21, thus coupling each pair of buoyant apparatuses 10 and preventing the bungee cord 21 from becoming tangled when the buoyant apparatuses 10 are in use.

A rudder 32 extends outwardly horizontally from the back end 26 of the outer frame 12. The rudder 32 provides stability and prevents the apparatus 10 from tipping backwards with the weight of the wearer when in use.

A plurality of fins 20 extend downwardly from the bottom surface 30 of the outer frame 12. The fins 20, similar to keels of a sailboat, provide stability to the buoyant apparatus 10 by preventing the buoyant apparatus 10 from tipping as the wearer exerts pressure. The fins 20 allow the outer frame 12 to maintain an equilibrium position after a small displacement, such as the weight of the wearer when pushing off one foot to travel along the surface of the water.

FIG. 2 illustrates a center fin 40 centrally positioned along the bottom surface 30 of the outer frame 12 and extends from the bow end 22 to the stern end 26 of the outer frame 12. The center fin 40 pushes the water outwardly from the buoyant apparatus 10 thus allowing the wearer to travel in a forward direction. The center fin 40 is similar to using a paddle in the water for kayaking or the blade of an ice skate for skating on an ice surface. Generally, when a skater uses ice skates with a center blade, the skater slides one foot outwardly away from their body in the desired direction in which to move. Similarly, the wearer of the buoyant apparatus 10 slides one foot outwardly away from their body pointing the center fin 40 in the desired direction.

The center fin 40 has two edges 42, including a fixed edge 42A integrally coupled to the bottom surface 30 of the outer frame 12 and a distal edge 42B extending downwardly therefrom. In the preferred embodiment, the center fin 40 is made from cross-linked plastic for increased durability. Preferably the center fin 40 extends downwardly approximately six inches (6″) from the bottom surface 30 of the outer frame 12. At the fixed end 42A the center fin 40 is approximately one fourth inch (¼″) in thickness tapering to one sixteenth inch ( 1/16″) in thickness at the distal end 42B.

A substantially circular hole 44 is centrally positioned within the center fin 40. A valve 46 is positioned within the hole 44 for both allowing and preventing water from flowing therethrough. The valve 46 is similar to a check valve well known in the art which allows water to flow in one direction and stops water from flowing in the opposite direction. Allowing water to flow through the hole 44 creates less resistance, while preventing water to flow through the hole 44 increases resistance. Specifically, as the wearer extends one foot outwardly, the valve 46 of the center fin 40 allows water to flow through the hole. This decreased resistance allows the wearer to easily slide the apparatus along the surface of the water. The valve 26 of the stationary apparatus 10, bearing the wearer's weight, prevents water from flowing through the hole. This increased resistance and pressure against the center fin 40 provides increased stability as the wearer is displacing water around the center fin 40 and thus stays afloat. The wearer then repeats the movement by pushing off the stationary apparatus 10. Thus, the wearer travels along the surface of water by using the buoyant apparatus 10.

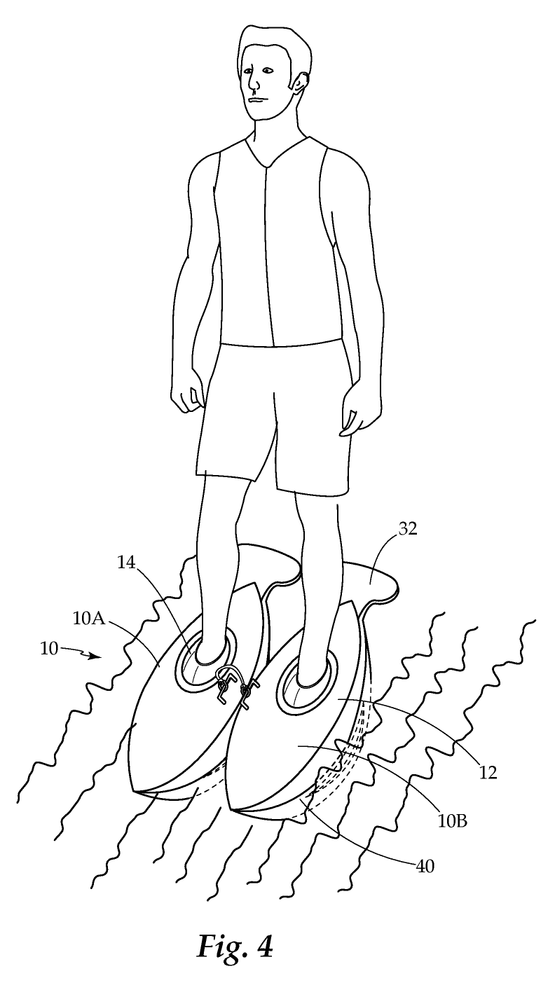

As shown in FIG. 3, a plurality of stabilizing fins 50 extend outwardly from the bottom surface 30 of the outer frame 12. Specifically, four stabilizing fins 50 are positioned with two stabilizing fins 50 on either side of the center fin 40. The positioning of the stabilizing fins 50 provides rotational stability to the outer frame 12. With a small angular displacement to the apparatus 10, such as the weight of the wearer sliding the apparatus 10 along the surface of the water, the stabilizing fins 50 allow the apparatus 10 to return to the original upright position. Thus, allowing the wearer to continue the motion required to travel along the surface of the water. An alternate embodiment is contemplated wherein two stabilizing fins 50 are positioned with one stabilizing fin 50 on either side of the center fin 40.

FIG. 4 illustrates the buoyant apparatus 10 of the present invention in use. The wearer first secures a life jacket around their torso in keeping with safety guidelines and procedures for water recreational activities. Preferably, the wearer is in a seated position along a dock or located along a shallow area of a body of water. The wearer then prepares to utilize a pair of buoyant apparatuses 10, specifically a right apparatus 10A, suitable for the wearer's right foot and a left apparatus 10B, suitable for the wearer's left foot, by simply sliding their right foot into the foot insert 14 of the right apparatus 10A and sliding their left foot into the foot insert 14 of the left apparatus 10B. Based on the wearer's skating ability, the wearer may decide to remove the bungee cords 21 removably coupled to the outer frame 12. The wearer squats or stands in a hunched position to balance and stabilize their weight onto the buoyant apparatuses 10A, 10B by aligning the buoyant apparatuses 10A, 10B. When the wearer feels their weight is evenly distributed between each buoyant apparatus 10, the wearer slowly stands upright. Novice wearer's may choose to utilize poles (not shown) to help balance and maneuver along the water.

To move in a forward direction and travel along the surface of water, the wearer extends the right apparatus 10A outwardly with the center fin 40 pointed slightly at a forty-five degree angle, placing their body weight on the left apparatus 10B. As the wearer extends the right apparatus 10A, the valve 46 of the center fin 40 allows water to flow through the hole 44, creating less resistance such that the right apparatus 10A easily slides along the surface of the water. With the wearer's body weight on the left apparatus 10B, the valve 46 of the center fin 40 prevents water from flowing through the hole 44, thus creating resistance and maintaining the stability of the left apparatus 10B as the wearer's weight is displaced over the water. The wearer then alternates their body weight from the left apparatus 10B to the right apparatus 10A and slides the left apparatus 10B outwardly with the center fin 40 pointed slightly at a forty-five degree angle past the right apparatus 10A in a forward direction. The wearer repeats the movement placing their body weight on the left apparatus 10B to travel forward along the surface of the water.

In conclusion, herein is presented a buoyant apparatus for use on a wearer's foot. The invention is illustrated by example in the drawing figures, and throughout the written description. It should be understood that numerous variations are possible, while adhering to the inventive concept. Such variations are contemplated as being a part of the present invention.

What is claimed is:

1. A buoyant apparatus for use on a wearer's foot comprising:
an outer frame;
a foot insert integrally coupled with the outer frame for accepting the wearer's foot; and
a plurality of fins.

2. The buoyant apparatus of claim 1 wherein the outer frame further comprises:
a bow end;
a center;
a stern end;
a port side;
a starboard side;
a top surface; and
a bottom surface.

3. The buoyant apparatus of claim 2, further comprising:
a bungee cord, wherein the bungee cord is removably coupled to the top surface of the outer frame, and further comprises:
a pair of ends, wherein each end possesses a clip;
a hook, wherein the hook is coupled to the top surface of the foot insert and is disposed to couple with one clip of the bungee cord; and
a rudder, wherein the rudder extends outwardly horizontally from the back end of the outer frame.

4. The buoyant apparatus of claim 3, wherein the plurality of fins extend downwardly from the bottom surface of the outer frame.

5. The buoyant apparatus of claim 1, further comprising:
a center fin, wherein the center fin is centrally positioned along the bottom surface of the outer frame and extends from the bow end to the stern end of the outer frame.

6. The buoyant apparatus of claim 2, wherein the center fin further comprises two edges, including a fixed edge integrally coupled to the bottom surface of the outer frame and a distal edge extending downwardly therefrom.

7. The buoyant apparatus of claim 6, further comprising:
a substantially circular hole centrally positioned within the center fin; and
a valve, wherein the value is positioned within the circular hole.

8. The buoyant apparatus of claim 5, further comprising:
a plurality of stabilizing fins, wherein the stabilizing fins extend outwardly from the bottom surface of the outer frame.

9. The buoyant apparatus of claim 8, wherein a pair of stabilizing fins are positioned on either side of the center fin.

10. A buoyant apparatus system comprising:
a pair of buoyant apparatus comprising:
a left buoyant apparatus, for use on a user's left foot, and a right buoyant apparatus for use on a user's right foot; wherein each buoyant apparatus further comprises:
an outer frame;
a foot insert integrally coupled with the outer frame for accepting the wearer's foot; and
a plurality of fins.

11. A method for travelling along the surface of water utilizing the system of claim 10, comprising the steps of:
placing a wearer's left foot in the foot insert of the left buoyant apparatus;
placing a wearer's right foot in the foot insert of the right buoyant apparatus;
aligning the buoyant apparatuses by having the wearer squat or stand in a hunched position to balance and stabilize the buoyant apparatuses; and
having the wearer of the buoyant apparatuses stand upright.

12. The method for travelling along the surface of water of claim 11, further comprising the steps of:
extending the wearer's right buoyant apparatus outwardly with a center fin of the right buoyant apparatus pointed slightly at a forty-five degree angle;
placing the wearer's body weight on the left buoyant apparatus;
extending the wearer's left buoyant apparatus outwardly with a center fin of the left buoyant apparatus pointed slightly at a forty-five degree angle;
placing the wearer's body weight on the right buoyant apparatus; and
repeating the steps of extending the wearer's right buoyant apparatus followed by extending the wearer's left buoyant apparatus.
